(19) United States
(12) Patent Application Publication
(10) Pub. No.: US 2024/0176291 A1
(43) Pub. Date: May 30, 2024

(54) VOLUMETRIC HOLOGRAPHIC DATA STORAGE DEVICES AND VOLUMETRIC HOLOGRAMS

(71) Applicant: HOLOMEM LTD, Croydon Greater London (GB)

(72) Inventors: Martin John RICHARDSON, Croydon Greater London (GB); Vivian Amos SURESH KUMAR, Croydon Greater London (GB); Roger Chris Keith ABBOTS, Croydon Greater London (GB)

(21) Appl. No.: 18/551,815

(22) PCT Filed: Mar. 22, 2022
(86) PCT No.: PCT/GB2022/050715

§ 371 Date: Sep. 21, 2023

(30) Foreign Application Priority Data
Mar. 23, 2021 (GB) GB 2104043.1

(51) Int. Cl. G03H 1/02; G03H 1/04

(52) U.S. Cl. CPC G03H 1/0248; G03H 1/0402; G03H 2001/0439

(57) ABSTRACT

There is provided a volumetric holographic data storage device for recording data in a volumetric holographic medium and/or reading data from a volumetric holographic medium, the volumetric holographic data storage device including at least one volumetric holographic optical element. There is also provided a volumetric holographic data storage device for recording data in a volumetric holographic medium and/or reading data from a volumetric holographic medium, the volumetric holographic data storage device including at least one optical fibre for carrying a signal beam and/or a reference beam. There is also provided use of a Holographic Optical Element in data storage.

### FIELD

The present disclosure relates to volumetric holographic data storage devices and volumetric holograms, specifically, although not exclusively, to volumetric holographic data storage devices including volumetric holographic optical elements.

### BACKGROUND

Volumetric holographic data storage devices are known but have yet to be commercialised in any substantial way, despite the potential for this technology to store large amounts of data in a practical way. This specification seeks to provide volumetric holographic data storage devices which may be commercialised.

### SUMMARY

There is provided a volumetric holographic data storage device for recording data in a volumetric holographic medium and/or reading data from a volumetric holographic medium,
the volumetric holographic data storage device including at least one volumetric holographic optical element.

The at least one volumetric holographic optical element may include:
a random phase mask HOE,
an edge-lit HOE;
a beam splitting HOE;
an objective lens HOE;
a Fourier transform lens HOE;
a focusing HOE;
an expanding HOE
a mirror HOE;
a beam shaping HOE;
a redirection HOE;
a polarization/half-wave plate/quarter-wave plate HOE;
a lens HOE;
a beam combiner HOE;
a fibre optic coupling HOE;
a data memory HOE;
a Fresnel lens HOE; and/or
a microgram within a microgram HOE.

The at least one volumetric holographic optical element may include a random phase mask HOE.

The at least one volumetric holographic optical element may include an edge lit HOE.

The at least one volumetric holographic optical element may include a beam shaping HOE.

The beam shaping HOE may be configured to reshape a Gaussian light intensity distribution to a flat-top light intensity distribution.

The volumetric holographic data storage device may be configured to record data in the volumetric holographic medium by:
wavelength multiplexing;
angular multiplexing;
phase multiplexing; and/or
spatial multiplexing.

The at least one volumetric holographic optical element may include a first and a second volumetric holographic optical element. The first and second volumetric holographic optical elements may be recorded in the same holographic optical element medium.

The first and second volumetric holographic optical elements may be recorded in the same holographic optical element medium by:
wavelength multiplexing;
angular multiplexing;
phase multiplexing; and/or
spatial multiplexing.

The volumetric holographic data storage device may further include a further volumetric holographic optical element. The volumetric holographic data storage device may be configured to record data in the volumetric holographic medium by diffracting light with the first and/or, if present, the second volumetric holographic optical element and diffracting light with the further volumetric holographic optical element to the volumetric holographic medium.

There is also provided a volumetric holographic data storage device for recording data in a volumetric holographic medium, the volumetric holographic data storage device including an arrangement for projecting an image containing data onto a random phase mask such that the image can be recorded in the volumetric holographic medium.

The random phase mask may be a random phase mask HOE.

The random phase mask may be a random phase mask DOE.

The random phase mask may be a wavelength selective random phase mask.

The random phase mask may be a panchromatic random phase mask.

The random phase mask may be a beam shaping random phase mask.

The volumetric holographic data storage device may further include a parallax barrier between the random phase mask and the volumetric holographic medium.

There is also provided a volumetric holographic data storage device for recording data in a volumetric holographic medium and/or reading data from a volumetric holographic medium, wherein the volumetric holographic data storage device includes at least one optical fibre for carrying a signal beam and/or a reference beam.

The volumetric holographic data storage device may further include a Spatial Light Modulator (SLM) and/or Digital Micromirror Device (DMD) and the optical fibre may be configured to carry information to or from the SLM and/or DMD.

The optical fibre may be a single mode fibre.

The volumetric holographic data storage device may further include a volumetric holographic optical element.

The volumetric holographic optical element may be configured to focus the signal beam and/or reference beam into the optical fibre.

The volumetric holographic data storage device described immediately above may further include one or more or all of the features of the other volumetric holographic data storage devices described herein.

There is also provided a volumetric holographic data storage device for recording data in a volumetric holographic medium, wherein the volumetric holographic data storage device is configured to record data in the volumetric holographic medium in a hexagonal discrete array of data pages.

There is also provided a volumetric holographic data storage device for recording data in a volumetric holographic medium, wherein the volumetric holographic data storage device is configured to record data in the volumetric holographic medium in a tessellated (e.g. hexagonal) array of discrete data pages.

The volumetric holographic data storage device may be configured to record data in the volumetric holographic medium in a hexagonal array of discrete data pages by recording a hexagonal array in a single interference structure.

The data storage device may be configured to record data in the volumetric holographic medium in a hexagonal array of discrete data pages by recording multiple optical interference structures in a hexagonal array.

The hexagonal array may include a planar hexagonal array.

The hexagonal array may include multiple planar hexagonal arrays.

There is also provided a volumetric holographic data storage device for recording data in a volumetric holographic medium, wherein the volumetric holographic data storage device is configured to record data in the volumetric holographic medium in a hexagonal interference structure.

The volumetric holographic data storage device may be configured to record data by:
wavelength multiplexing;
angular multiplexing;
phase multiplexing; and/or
spatial multiplexing.

The volumetric holographic data storage device may be additionally configured for reading data from the volumetric holographic medium.

There is also provided a volumetric holographic data storage device for recording data in a volumetric holographic medium,
wherein the data storage device is configured to record data in the volumetric holographic medium by passing light (such as coherent monochromatic light, e.g. laser light) through or reflecting light (such as coherent monochromatic light, e.g. laser light) off a Spatial Light Modulator and/or a digital micromirror device (DMD) to the volumetric holographic medium,
and wherein between the Spatial Light Modulator and/or a digital micromirror device (DMD) and the volumetric holographic medium the image is compressed by a factor of at least 10⁻², 10⁻³, 10⁻⁴, 10⁻⁵, or 10⁻⁶.

The volumetric holographic data storage device may be further configured to record data by:
wavelength multiplexing;
angular multiplexing;
phase multiplexing; and/or
spatial multiplexing.

The volumetric holographic data storage device may be further configured to read data by:
wavelength demultiplexing;
angular demultiplexing;
phase demultiplexing; and/or
spatial demultiplexing.

There is also provided a volumetric holographic data storage device for recording data in a volumetric holographic medium,
wherein the data storage device is configured to record data in the volumetric holographic medium in at least a first data page and a second data page,
and wherein the first data page and the second data page include identical data.

The data storage device may be configured to record data in the volumetric holographic medium in a microgram.

The data storage device may be further configured to record data in the volumetric holographic medium in an array of micrograms within a single interference structure in the volumetric holographic medium.

The data storage device may be configured to record data in the volumetric holographic medium in a hexagonal array of discrete data pages by recording multiple optical interference structures in a hexagonal or other geometric array.

The hexagonal or other geometric array may be within a hexagonal or other geometric array.

There is also provided a volumetric holographic data storage device for reading data from a volumetric holographic medium,
wherein the volumetric holographic data storage device is configured to read data from at least a first data page and a second data page of the volumetric holographic medium,
and wherein data storage device is configured to verify accurate reading of the data by comparing data from the first data page and data from the second data page.

There is also provided a volumetric holographic data storage device for reading data from a volumetric holographic medium,
wherein the volumetric holographic data storage device is configured to read data from a volumetric holographic medium by illuminating the volumetric holographic medium by diffracting light with a volumetric holographic optical element.

The volumetric holographic data storage device may be further configured to read data by:
wavelength demultiplexing;
angular demultiplexing;
phase demultiplexing; and/or
spatial demultiplexing.

The volumetric holographic data storage devices described herein may further include one or more or all of the features of the other volumetric holographic data storage devices described herein.

There is also provided a volumetric hologram including a volumetric holographic medium, the volumetric holographic medium including an interference structure which when illuminated displays a projection of a data page information on a hologram or random phase mask.

There is also provided a volumetric hologram including a volumetric holographic medium, the volumetric holographic medium including an interference structure which when illuminated displays a hexagonal array of discrete data pages.

There is also provided a volumetric hologram including a volumetric holographic medium, the volumetric holographic medium including a hexagonal array of interference structures, each interference structure containing a discrete data page.

There is also provided a volumetric hologram including a volumetric holographic medium, the volumetric holographic medium including an interference structure which when illuminated displays at least a first data page and a second data page,
and wherein the first data page and the second data page include identical data.

There is also provided a volumetric hologram including a volumetric holographic medium, the volumetric holographic medium including at least a first interference structure which when illuminated displays a first data page and a second interference structure which when illuminated displays a second data page,
and wherein the first data page and the second data page include identical data.

There is also provided use of a Holographic Optical Element in data storage.

### DESCRIPTION OF THE FIGURES

In order that the present disclosure may be more readily understood, preferable embodiments thereof will now be described, by way of example only, with reference to the accompanying drawings, in which:

FIG. 1 is a schematic diagram of a volumetric holographic data storage device in accordance with an embodiment of the present disclosure;

FIG. 2 is a schematic diagram of a volumetric holographic data storage device in accordance with a further embodiment of the present disclosure;

FIG. 3 is a schematic diagram of a volumetric holographic data storage device in accordance with a further embodiment of the present disclosure;

FIG. 4 is a schematic diagram of a volumetric holographic data storage device in accordance with a further embodiment of the present disclosure;

FIG. 5 is a schematic diagram of a volumetric holographic data storage device in accordance with a further embodiment of the present disclosure;

FIG. 6 is a schematic diagram of a volumetric holographic data storage device in accordance with a further embodiment of the present disclosure;

FIG. 7 is a schematic diagram of a volume hologram recorded using the volumetric holographic data storage device of FIG. 6;

FIG. 8 is a schematic diagram of a volumetric holographic data storage device in accordance with a further embodiment of the present disclosure;

FIG. 9 is a schematic diagram of a volumetric holographic data storage device in accordance with a further embodiment of the present disclosure; and

FIG. 10 is a schematic diagram of a volumetric holographic data storage device in accordance with a further embodiment of the present disclosure.

### DESCRIPTION OF EMBODIMENTS

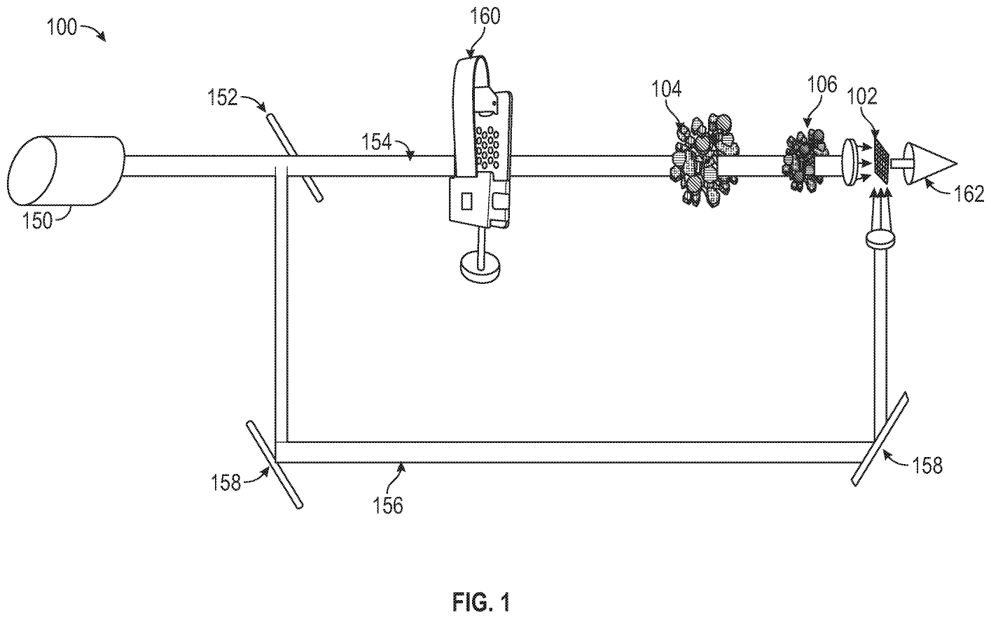

Referring firstly to FIG. 1 of the drawings, there is provided a volumetric holographic data storage device, shown schematically and indicated generally at 100. The volumetric holographic data storage device 100 is for recording data in a volumetric holographic medium 102 and/or reading data from a volumetric holographic medium 102. The volumetric holographic data storage device 100 includes at least one volumetric holographic optical element (HOE). As shown in FIG. 1, the volumetric holographic data storage device 100 may include a multi-functional HOE 104 and/or an edge-lit HOE 106, either or both of the multi-functional HOE 104 and/or the edge-lit HOE 106 may make up the at least one volumetric HOE.

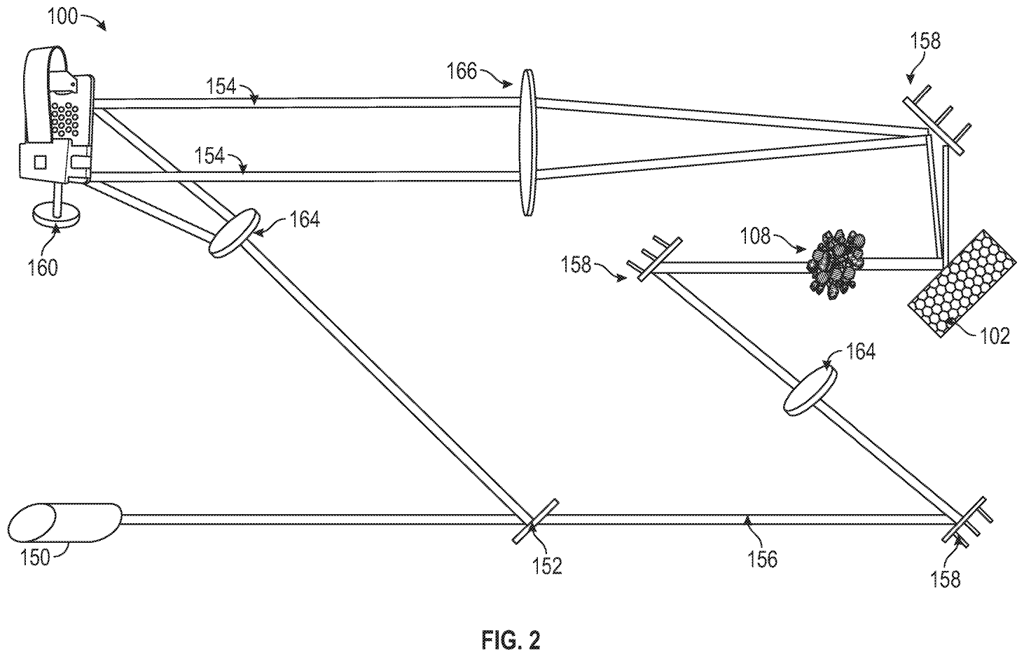

FIG. 2 shows a further volumetric holographic data storage device, shown schematically and indicated generally at 100. The volumetric holographic data storage device 100 is for recording data in a volumetric holographic medium 102 and/or reading data from a volumetric holographic medium 102. The volumetric holographic data storage device 100 also includes at least one volumetric holographic optical element (HOE). As shown in FIG. 2, the volumetric holographic data storage device 100 may include a beam shaping HOE 108. In this case, the beam shaping HOE 108 is the at least one volumetric HOE.

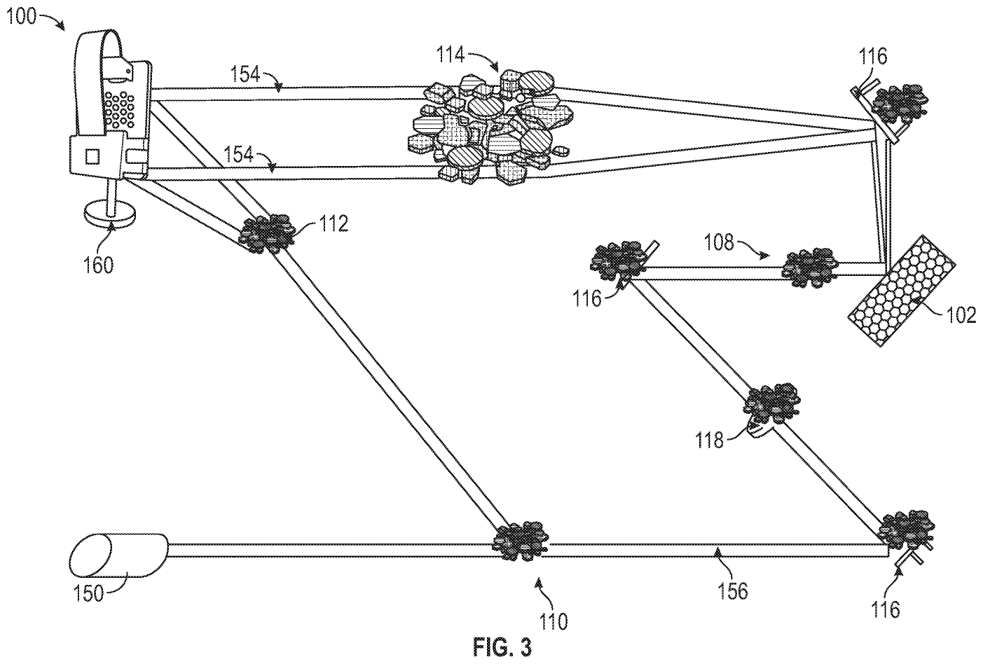

FIG. 3 shows a further volumetric holographic data storage device, shown schematically and indicated generally at 100. The volumetric holographic data storage device 100 is for recording data in a volumetric holographic medium 102 and/or reading data from a volumetric holographic medium 102. The volumetric holographic data storage device 100 also includes at least one volumetric holographic optical element (HOE). As shown in FIG. 3, the volumetric holographic data storage device 100 may include a beam shaping HOE 108, as with the volumetric holographic data storage device 100 of FIG. 2. As shown in FIG. 3, the volumetric holographic data storage device 100 may further include a beam splitting HOE 110, an objective lens HOE 112, a Fourier transform lens HOE 114, a mirror HOE 116, and/or an objective lens HOE 118. Any one or more of the beam splitting HOE 110, the objective lens HOE 112, the Fourier transform lens HOE 114, the mirror HOE 116, and/or the objective lens HOE 118 may make up the at least one volumetric HOE.

With reference to FIGS. 1, 2, and 3 in some embodiments the HOEs 104, 106, 108, 110, 112, 114, 116, 118 included in the volumetric holographic data storage devices 100 are being used to replace conventional elements of known holographic data storage devices. Indeed, it is a key realisation of the present disclosure that HOEs can be used to advantage to replace conventional optical elements in volumetric holographic data storage devices 100. The use of HOEs in volumetric holographic data storage devices 100 may be advantageous. In particular, such volumetric holographic data storage devices 100 may be more robust, as HOEs 104, 106, 108, 110, 112, 114, 116, 118 may be more robust than their conventional optical equivalents. Further, such volumetric holographic data storage devices 100 may be smaller, as HOEs 104, 106, 108, 110, 112, 114, 116, 118 may be smaller than their conventional optical equivalents. Further, such volumetric holographic data storage devices 100 may be more reliable, as HOEs 104, 106, 108, 110, 112, 114, 116, 118 may provide less signal degradation and loss than their conventional optical equivalents.

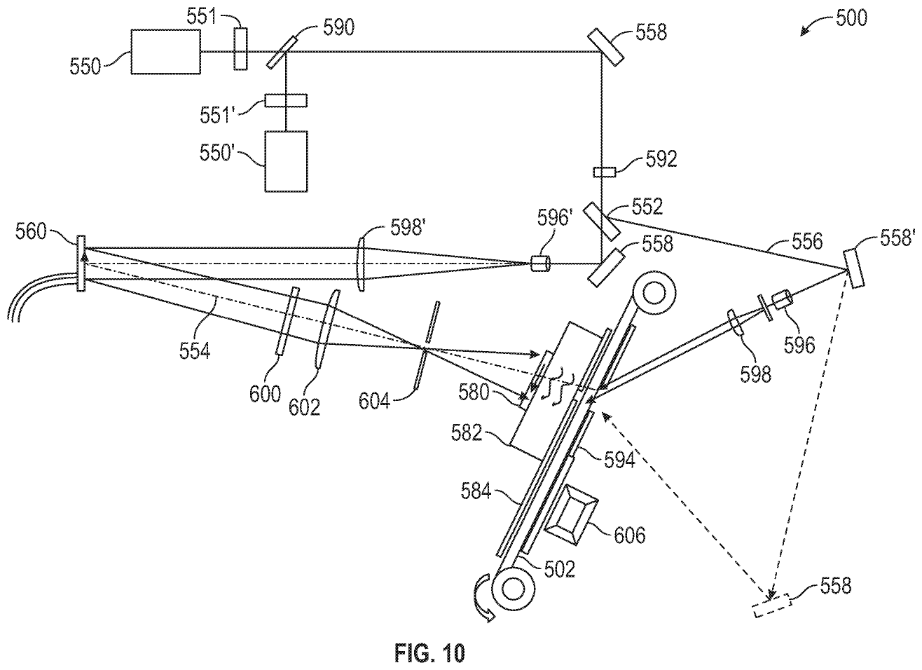

Accordingly, the present disclosure provides volumetric holographic data storage devices 100 including an edge-lit HOE 106, FIG. 1; a beam splitting HOE 110, FIG. 3; an objective lens HOE 112, FIG. 3; a Fourier transform lens HOE 114, FIG. 3; a focusing HOE (not shown); an expanding HOE (not shown); a mirror HOE 116, FIG. 3; a beam shaping HOE 108, FIGS. 2 and 3; a redirection HOE (not shown); a polarization/half-wave plate/quarter-wave plate HOE (not shown); a lens HOE (e.g. objective lens HOE 112, Fourier transform lens HOE 114); a beam combiner HOE (not shown); a fibre optic coupling HOE (not shown); a data memory HOE (not shown); a Fresnel lens HOE (not shown); and/or a microgram within a microgram HOE (not shown). The present disclosure also provides volumetric holographic data storage devices 100 including a random phase mask HOE (shown in FIG. 10). These may be advantageous, as described above and elsewhere herein.

As is apparent from the present disclosure, a large number of HOEs can be incorporated within volumetric holographic data storage devices 100 to obtain possible advantages from the present disclosure. Such HOEs may be manufactured using known techniques; accordingly, the manufacture of HOEs is not described herein.

With reference to FIG. 1, the at least one volumetric holographic optical element may include an edge lit HOE 106. Use of an edge lit HOE 106 may be particularly advantageous as the edge lit HOE 106 can be used to compress relatively large amounts of data into a relatively small (portion of) volumetric holographic medium 102.

With reference to FIGS. 2 and 3, the at least one volumetric holographic optical element may include a beam shaping HOE 108. As shown, the beam shaping HOE 108 may be configured to reshape a Gaussian light intensity distribution to a flat-top light intensity distribution. Reshaping of the light intensity distribution in this way may be particularly advantageous. In particular, in conventional holography, a non-uniform distribution of light intensity across the holographic medium 102 may be acceptable. Typically, such a non-uniform distribution of light intensity will result in the holographic image being brighter in the centre of the holographic medium 102 and duller at the edges or fringes of the holographic medium 102. For a conventional, e.g. artistic, hologram such an image may be considered attractive, i.e. to have a pleasing aesthetic. However, in the case of data storage regions of the holographic medium 102 having a reduced light exposure during recording can result in data corruption, which is undesirable. Use of a beam shaping HOE 110 in the volumetric holographic data storage device 100 may reduce or eliminate such areas of reduced exposure resulting in increased reliability of data storage.

The volumetric holographic data storage device 100 may be configured to record data in the volumetric holographic medium 102 by wavelength multiplexing; angular multiplexing; phase multiplexing; and/or spatial multiplexing. Such multiplexing can increase the amount of data which it is possible to record in the volumetric holographic medium 102. For example, using angular multiplexing it may be possible to record a different holographic image in the holographic medium 102 at angles separated by 0.1° over a 90° range—i.e. 900 images. As will be apparent, each image may contain data and therefore these techniques may be used to record a large amount of data.

The term “multiplexing” is used to refer to the encoding of multiple data sets, in some instances it may be preferred to refer to “entanglement” and/or “correlation” instead of or as well as “multiplexing”.

As shown in FIG. 1, the at least one volumetric holographic optical element may include a multi-functional HOE 104. A multi-functional HOE 104 includes at least a first and a second volumetric holographic optical element. The first and second volumetric holographic optical elements may be recorded in the same holographic optical element medium. The first and second volumetric holographic optical elements may be recorded in the same holographic optical element medium by: wavelength multiplexing; angular multiplexing; phase multiplexing; and/or spatial multiplexing. Accordingly, the function of the multi-functional HOE 104 may be selected by varying the wavelength of illumination, angle of illumination, phase of illumination, and/or location of illumination. As an example, where wavelength multiplexing is used, by changing the wavelength of illumination, the function of the multi-functional HOE may be changed. In such a case, when illuminated at a first wavelength the multi-functional HOE 104 may function as a first lens, for example, and when illuminated at a second wavelength the multi-functional HOE 104 may function as a second lens, for example. In such a case, the holographic optical element medium may have recorded in it first and second interference structures which provide the first and second volumetric HOEs. Such HOEs may be manufactured using known techniques; accordingly, the manufacture of HOEs is not described herein. As will be apparent, the use of such multi-functional HOEs may be advantageous, as, for example, volumetric holographic data storage devices 100 having fewer components can be provided.

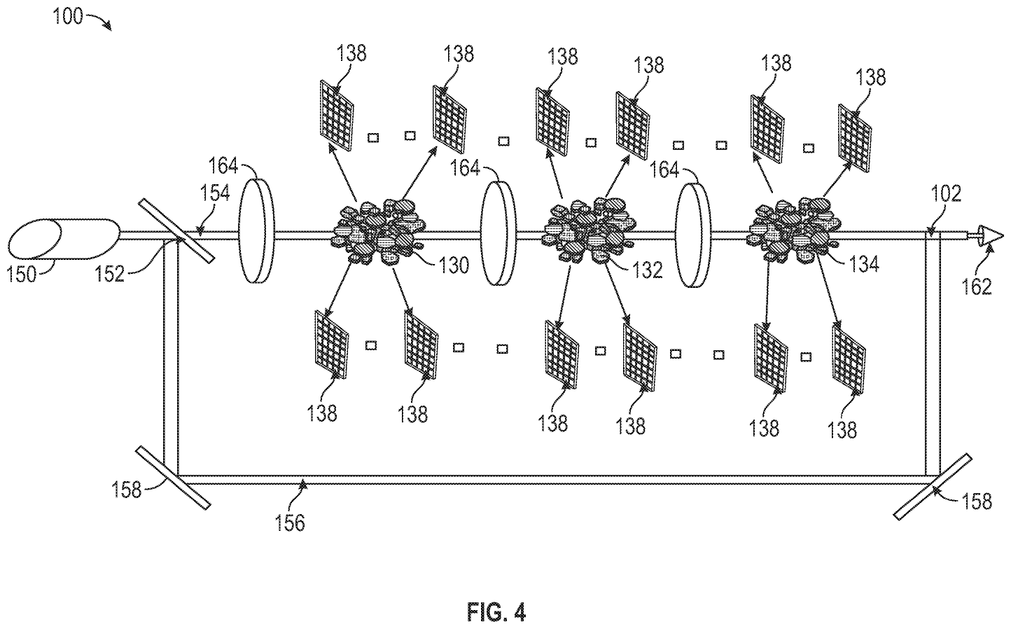

FIG. 4 shows another volumetric holographic data storage device 100 for recording data in a volumetric holographic medium 102 and/or reading data from a volumetric holographic medium 102. The volumetric holographic data storage device 100 includes at least one volumetric HOE. As shown, the volumetric holographic data storage device 100 may include a first multi-functional HOE 130, a second multi-functional HOE 132, and/or a third multi-functional HOE 134. Light from the signal beam (as illustrated, an object beam 154) may be first diffracted by the first multi-functional HOE 130, then by the second multi-functional HOE 132, and then by the third multi-functional HOE 134. As will be appreciated, in this case, the second and third multi-functional HOEs 132, 134 may be further volumetric HOEs. After the object beam 154 is diffracted by the first, second, and/or third multi-functional HOE 130, 132, 134 the beam arrives at the volumetric holographic medium 102 and an interference structure is recorded to form a hologram. As will be apparent, the data recorded in the holographic medium 102 may be a combination of the data contained within the first, second, and/or third multi-functional HOEs 130, 132, 134. The data, or holographic content, contained within the first, second, and/or third multi-functional HOEs 130, 132, 134 is represented schematically as the holographic images 138. Accordingly, a summation of spatially differentiated spectral data set, or sets (which are recorded in the first, second, and/or third multi-functional HOEs 130, 132, 134), may be recorded as volumetric HOEs in the holographic medium 102. This recording of precise, unique, optical data sets using HOEs to form multi-functional volumetric holograms within the volumetric holographic medium 102 has been designed to maximise the potential for optical data storage. Accordingly, the volumetric holographic data storage device 100 may be able to store vast amounts of information.

FIGS. 1, 3, and 4 show volumetric holographic data storage devices 100 which include multiple HOES 104, 106, 108, 110, 112, 114, 116, 118. Accordingly, the disclosed volumetric holographic data storage devices 100 may include a further volumetric HOE 104, 106, 108, 110, 112, 114, 116, 118. As shown, the volumetric holographic data storage device 100 may be configured to record data in the volumetric holographic medium 102 by diffracting light with the first and/or, if present, the second volumetric HOE 104, 106, 108, 110, 112, 114, 116, 118 and diffracting light with the further volumetric holographic optical element 104, 106, 108, 110, 112, 114, 116, 118 to the volumetric holographic medium 102.

FIG. 10 shows a further volumetric holographic data storage device, shown schematically and indicated generally at 500. The volumetric holographic data storage device 500 is for recording data in a volumetric holographic medium 502 and/or reading data from a volumetric holographic medium 502. The volumetric holographic data storage device 500 includes an arrangement for projecting an image containing data onto a random phase mask 580 such that the image can be recorded in the volumetric holographic medium 502.

The reconstruction of the holographic random phase mask is enabled by the incident light source in which the data page information is being projected. This construct is then further recorded as a volumetric holographic data carrier.

A particular arrangement is shown in FIG. 10; however, any alternative arrangement which is capable of projecting an image containing data onto a random phase mask 580 may be used.

By providing the random phase mask 580 onto which an image containing data is projected and then recording this projection into the volumetric holographic medium 502 a Fourier transform hologram is formed. The reconstruction of the holographic phase mask may be enabled by a coherent light source, reflected from an SLM 560 and/or DMD. The coherent light source may also carry data. The hologram so formed is described as a Fourier transform hologram as the projected image is not in focus at the volumetric holographic medium 502. Accordingly, Fourier transform multiplexing is possible. For example, Fourier transform multiplexing may be achieved by positioning the random phase mask 580 at multiple depths (e.g. multiple distances from the volumetric holographic medium 502).

As will be apparent, in this way efficient use of the holographic medium 580 may be enabled. In particular, using this arrangement may be possible to record an image (e.g. an image containing a data page) in a small portion of the holographic medium 580. Accordingly, it may be possible to record a greater number of images (or data pages) within a given size of holographic medium.

As will be apparent, the random phase mask 580 may be described as an optical random phase mask and/or an holographic random phase mask. Further, the image may be described as a projected image. Additionally or alternatively, the random phase mask 580 may be or be described as a diffuser.

As shown in FIG. 10, the random phase mask 580 may be spaced from the volumetric holographic medium 502, for example, spaced by an optically clear spacer 582. The optically clear spacer may be or comprise an air gap or any other suitable alternative.

In the volumetric holographic data storage device 500 the random phase mask 580 may a random phase mask HOE. Providing the random phase mask 580 as a random phase mask HOE may provide the advantages associated with providing any component as a HOE as described herein; including robustness, compactness, reliability, and reduced signal degradation and loss than optical equivalents. Additionally, providing the random phase mask 580 as a random phase mask HOE may be more efficient than use of a classical optical random phase mask, as the random phase mask HOE may have less speckle and less scattering in non-desired directions than a conventional random phase mask.

Additionally or alternatively, the random phase mask 580 may be a random phase mask Diffractive Optical Element (DOE).

The random phase mask 580 may be a wavelength selective random phase mask. A possible advantage of the use of a wavelength selective random phase mask is that the random phase mask may be more controllable. By using a wavelength selective random phase mask superior hologram recording may be achieved as only appropriate, desired, wavelengths will be scattered by the wavelength selective random phase mask. It may be that using a wavelength specific random phase mask results in holograms which are easier to read with a (relatively) inexpensive laser—in other words, reading of the hologram may be simpler.

The random phase mask 580 may be a panchromatic random phase mask. A panchromatic random phase mask scatters a range, usually a broad range, of different wavelengths of light. Use of a panchromatic random phase mask may be preferred and/or useful where wavelength multiplexing by the volumetric holographic data storage device 500 is desired. In particular, use of a panchromatic random phase mask may mean that multiple random phase masks are not required to record holograms or interference structures at multiple wavelengths.

The random phase mask 580 may be a beam shaping random phase mask. A beam shaping random phase mask scatters light within a particular field, as opposed to a non-beam shaping random phase mask which scatters light evenly through a 360° field. Such a beam shaping random phase mask may be or be described as a “focused” random phase mask and/or an “anti reflective” random phase mask. Use of a beam shaping random phase mask may reduce light wastage and provide associated advantages, for example, shorter duration exposure times, use of lower powered light sources, etc.

The volumetric holographic data storage device 500 may further include a parallax barrier 584 between the random phase mask 580 and the volumetric holographic medium 502. The parallax barrier 584 may be or include an aperture in an opaque material. The parallax barrier 584 can enable the volumetric holographic data storage device 500 to record a data page is a relatively small portion of the volumetric holographic medium 502, leaving the remainder of the volumetric holographic medium 502 available for the recording of further data pages. In this way, the density of the data recorded in the volumetric holographic medium 502 may be relatively high.

As will be appreciated, using the volumetric holographic data storage device 500 shown in FIG. 10 a volumetric holographic medium 502 including an interference structure which when illuminated displays a projection on a hologram or random phase mask may be recorded. Recording and using such a hologram may provide the above described advantages.

The volumetric holographic data storage devices 500 in addition to the features described may further include conventional features of volumetric holographic data storage devices and/or features specifically adapted to be used with the arrangement for projecting an image containing data onto the random phase mask 580. For example, the volumetric holographic data storage device 500 may include a light source 550, 550′, such as a coherent monochromatic light source, e.g. laser light sources 550, 550′. Use of two light sources 550, 550′ is a way of providing multiple, differing, wavelengths of light. Accordingly the arrangement of FIG. 10 shows a schematic diagram of a multiplexed dual wavelength volumetric holographic data storage device 500 which may extend to multiple wavelengths of a volumetric holographic data storage device. Light from the light source(s) 550, 550′ may be controlled by opto-acoustic modulators 551, 551′ acting as shutters. Such modulators may be capable of delivering simultaneous, consecutive, or interspersed exposure within the volumetric holographic data storage device 500.

Light from the light sources 550, 550′ may be arranged to be incident upon a dichroic mirror 590 (which may be a HOE). The dichroic mirror may be arranged combine the beams of light from the light sources 500, 550′ to provide a single combined coaxial beam.

A half-waveplate 592 may used to control the plane of linear polarisation of light within the volumetric holographic data storage device 500. In particular, where a LCoS type SLM 560 is used, there may be a need to ensure suitable polarisation of the incident light on SLM 560. In other arrangements, e.g., with differing types of SLM 560 such a half-waveplate may not be necessary or advantageous.

The volumetric holographic data storage device 500 may include a beam splitter 552. The beam splitter may be a polarizing beam splitter, in which case a half-waveplate 592 may not be necessary even if a LCos type SLM 560 is used. The beam splitter 552 is a way of providing for a portion of light to be separated to provide a reference beam 556 for the hologram-recording process. As shown, the reference beam 556 is reflected by a mirror 558′. The mirror 558′ may be a solenoid-controlled reflector, which may be able to direct the reference beam 556 towards the holographic medium 502.

The holographic medium 502 may be shielded by an exposure gate defined by an apertures in a protective mask 594.

The volumetric holographic data storage device 500 may further include a spatial filter 596 and/or collimating lens 598 for shaping the reference beam 556. Such spatial filter 596 and collimating lens 598 might be located in alternative locations to those illustrated in FIG. 10, as would be apparent to the skilled person.

The object beam 554 may pass through a spatial filter 596′ and/or collimating lens 598′ as a way providing parallel illumination to an SLM 560. The SLM 560 can be used to display and/or project page(s) of coded data. As shown, the object beam 554 may be filtered by a circular polariser 600. The object beam 554 may also focused by a lens 602. The object beam may also pass through an aperture 604 to produce an image at the random phase mask 580.

Where the volume holographic medium 502 is (e.g.) a photopolymer, the recorded interference structures may form during light exposure and the medium 502 may be cured by the application of ultra-violet light, for example from an LED lamp 606. As will be apparent to the skilled person different volume holographic media have different recording requirements, for example, silver halide systems involve a separate processing step(s), as are known per se.

The volumetric holographic data storage device 500 may include a (film) transport arrangements for manipulation of the volumetric holographic medium 502. For example, linear movement of reel-to-reel film systems, which may involve cassette-type applicators, and/or rotational disc-driven exposure placement systems. A film system having the ability to position volumetric holographic medium 502 in such a way as to allow individual exposure zones to receive position stable exposure by appropriate X-Y movements of film may be used. Individual exposure zones may be tessellated (including but not limited to square, rectangular, or hexagonal shapes), to enable large coverage and high density recording within the volumetric holographic medium 502.

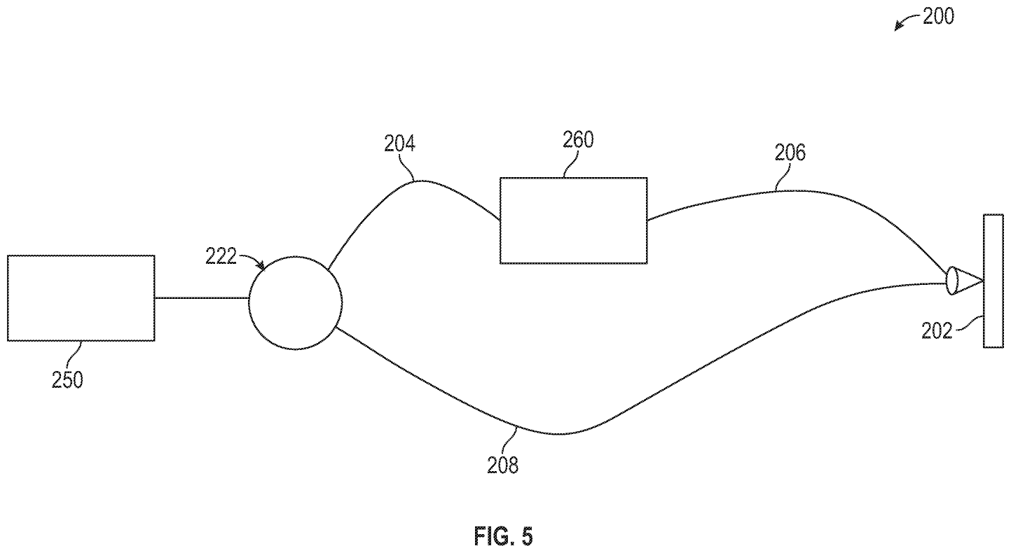

As shown in FIG. 5, there is also provided a volumetric holographic data storage device 200 for recording data in a volumetric holographic medium 202 and/or reading data from a volumetric holographic medium 202, wherein the volumetric holographic data storage device 200 includes at least one optical fibre 204, 206, 208 for carrying a signal beam and/or a reference beam. As shown in FIG. 5, the optical fibres 204, 206 are for carrying a signal beam and the optical fibre 208 is for carrying a reference beam. The signal beam may be light traveling to the volumetric holographic medium 202 during recording of data (as shown in the arrangement of FIG. 5) and/or the signal beam may be light traveling from the volumetric holographic medium 202 during reading of data (not shown). As is apparent, the optical fibres 204, 206, 208 are being used to replace conventional straight light paths in known holographic data storage devices. Indeed, it is a key realisation of the present disclosure that optical fibres can be used to advantage to replace straight light paths in volumetric holographic data storage devices 100. The use of optical fibres 204, 206, 208 in volumetric holographic data storage devices 100 may be advantageous. In particular, such volumetric holographic data storage devices 200 may be more robust, as components connected by optical fibres do not have to remain in perfect alignment since components connected by optical fibres may move relative to each other and still allow light to pass along the intended pathway. Further, such volumetric holographic data storage devices 200 may be smaller, as the use of optical fibres can enable components of the volumetric holographic data storage devices 200 to be laid out more efficiently than in arrangements where straight light paths are required. For example, where it is desired to bend light by an oblique angle such arrangements are much more accessible with the use of an optical fibre, than with conventional optics. Further, such volumetric holographic data storage devices 200 may be more reliable, as signal degradation and loss may be reduced by the use of optical fibres.

The volumetric holographic data storage device 200 may further include a Spatial Light Modulator (SLM) 220 and/or Digital Micromirror Device (DMD) (not shown), such components may have the same function as in conventional volumetric holographic data storage devices. As shown, the optical fibre 204, 206 may be configured to carry information to or from the SLM 220 and/or DMD.

The optical fibre may be a single mode fibre; for example, a multi-core single mode fibre. Use of a single mode fibre can reduce or avoid modal noise and thereby increase the accuracy and reliability of the volumetric holographic data storage device 200.

The volumetric holographic data storage device 200 may further include a volumetric holographic optical element. For example, as shown in FIG. 5, the volumetric holographic data storage device 200 includes a fibre optic directional coupler 222. The fibre optic directional coupler 222 may be entirely fabricated from volumetric HOE(s) or include HOE(s). In particular, the volumetric holographic optical element may be configured to focus the signal beam and/or reference beam into the optical fibres 204, 208.

As will be apparent, the volumetric holographic data storage device 200 described with reference to FIG. 5 may further include one or more or all of the features of the other volumetric holographic data storage devices described herein. Additionally or alternatively, the other volumetric holographic data storage devices described herein may further include one or more of the features of the volumetric holographic data storage device 200 described with reference to FIG. 5.

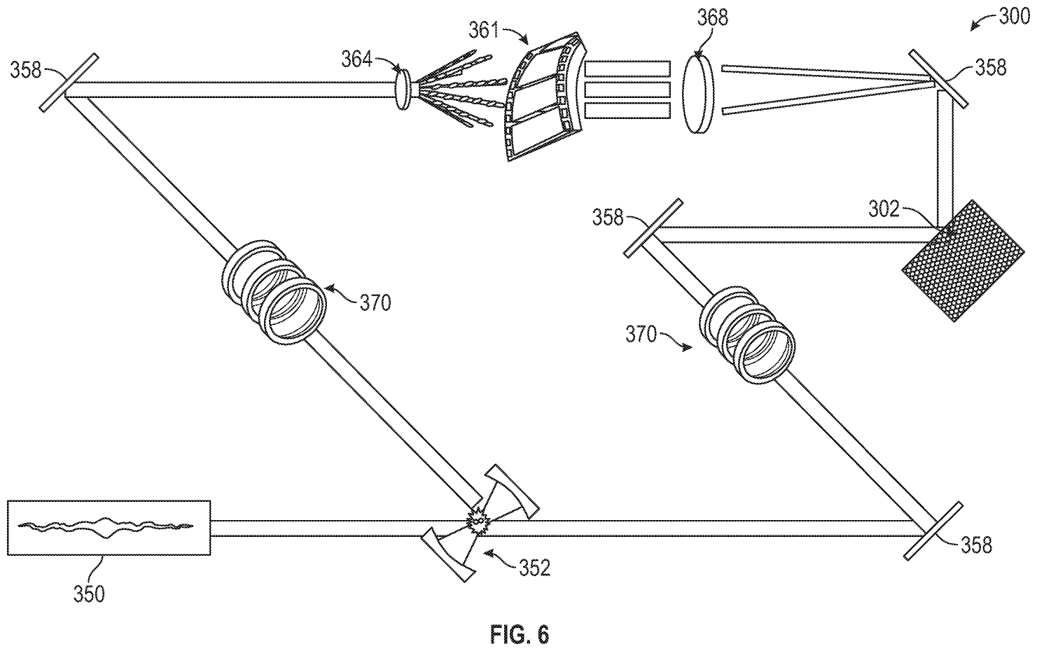

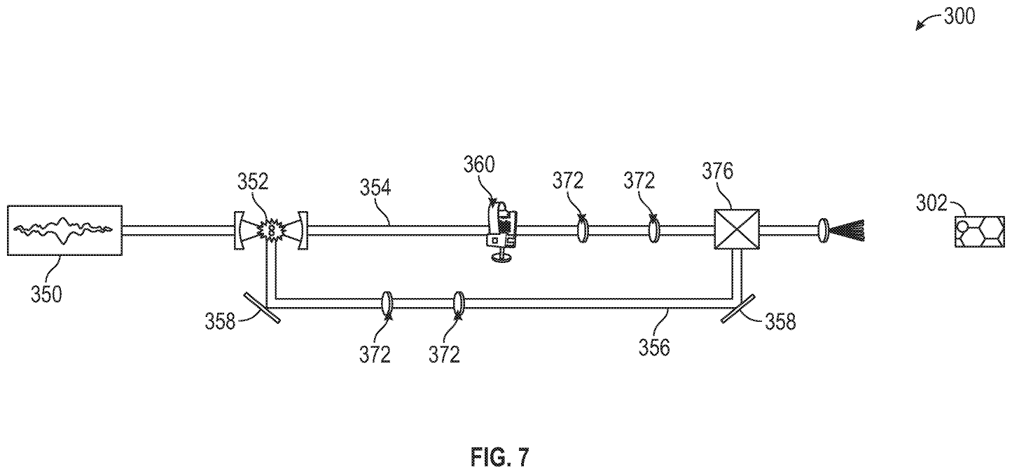

As shown with reference to FIGS. 6 and 7, there is also provided a volumetric holographic data storage device 300 for recording data in a volumetric holographic medium 302, wherein the volumetric holographic data storage device 300 is configured to record data in the volumetric holographic medium 302 in a hexagonal discrete array of data pages.

Additionally or alternatively, there is also provided a volumetric holographic data storage device 300 for recording data in a volumetric holographic medium 302, wherein the volumetric holographic data storage device 300 is configured to record data in the volumetric holographic medium 302 in a tessellated (e.g. hexagonal) array of discrete data pages.

The volumetric holographic data storage device 300 may be configured to record data in the volumetric holographic medium 302 in a hexagonal array of discrete data pages by recording a hexagonal array in a single interference structure. Additionally or alternatively, the data storage device may be configured to record data in the volumetric holographic medium in a hexagonal array of discrete data pages by recording multiple optical interference structures in a hexagonal array.

The hexagonal array may include a planar hexagonal array. The hexagonal array may include multiple planar hexagonal arrays. As will be appreciated, multiple planar hexagonal arrays will resemble a bee hive in structure. Whilst all hexagonal arrays may facilitate efficient recording of data within the volumetric holographic medium 302, such an arrangement may be particularly efficient.

As shown with reference to FIGS. 6 and 7, there is also provided a volumetric holographic data storage device 300 for recording data in a volumetric holographic medium 302, wherein the volumetric holographic data storage device is configured to record data in the volumetric holographic medium in a hexagonal interference structure. Recording data in an hexagonal interference structure may facilitate efficient recording of data within the volumetric holographic medium 302.

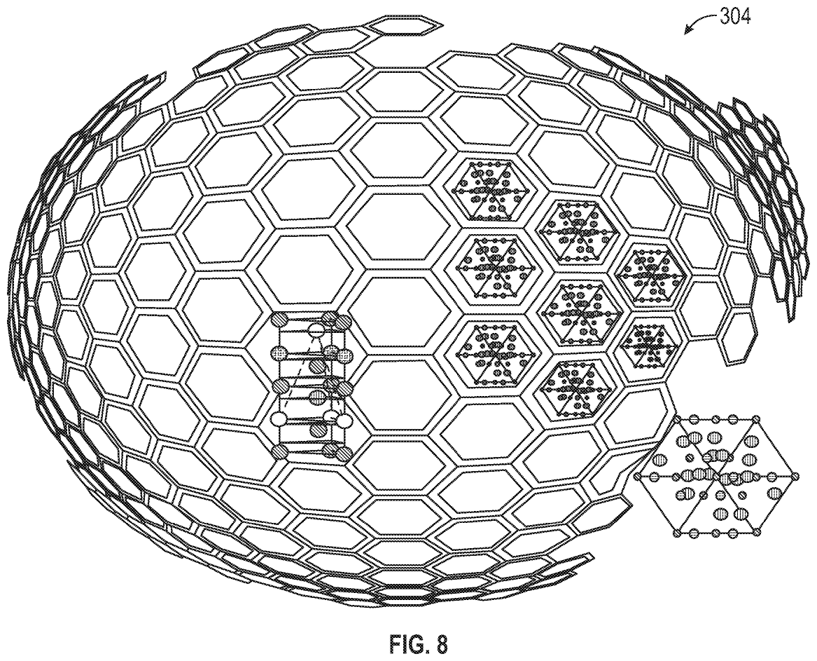

FIG. 8 shows an example hexagonal array 304 of discrete data pages. The example hexagonal array 304 may be a hexagonal array of discrete data pages recorded in a single interference structure or a hexagonal array of multiple optical interference structures.

In a similar way to that described above, the volumetric holographic data storage devices 300 of FIGS. 6 and 7 may be configured to record data by: wavelength multiplexing; angular multiplexing; phase multiplexing; and/or spatial multiplexing. The advantages obtained thereby may also be similar.

The volumetric holographic data storage devices 100, 200, 300 may be additionally configured for reading data from the volumetric holographic medium 102, 202, 302.

As shown with reference to FIG. 6, there is also provided a volumetric holographic data storage device 300 for recording data in a volumetric holographic medium 302, wherein the data storage device 300 is configured to record data in the volumetric holographic medium 302 by passing light (such as coherent monochromatic light, e.g. laser light) through or reflecting light (such as coherent monochromatic light, e.g. laser light) off a Spatial Light Modulator 320 and/or a digital micromirror device (DMD) (not shown) to the volumetric holographic medium 302. Further, between the Spatial Light Modulator 320 and/or a digital micromirror device (DMD) and the volumetric holographic medium the image is compressed by a factor of at least 10⁻², 10⁻³, 10⁻⁴, 10⁻⁵, or 10⁻⁶. Such image compression can allow a greater amount of data to be recorded in a holographic medium 302 than without such image compression.

Such image compression may be achieved using a collimating lens 368, as shown in FIG. 6. As will be apparent, the collimating lens 368 may be substituted with a volumetric HOE. This may provide the advantages described above.

In reading data from the holographic medium 302 it may not be required to have a especial arrangement for reading the holographic medium 302 as light diffracted from the holographic medium 302 may be dispersed by the interference structure recorded in the holographic medium 302.

As described above, the volumetric holographic data storage device 300 may be further configured to record data by: wavelength multiplexing; angular multiplexing; phase multiplexing; and/or spatial multiplexing. This may provide the advantages described above.

The volumetric holographic data storage device 300 may be further configured to read data by: wavelength demultiplexing; angular demultiplexing; phase demultiplexing; and/or spatial demultiplexing. Indeed wherever data is recorded using multiplexing herein, the data may be read with corresponding demultiplexing.

There are also provided a volumetric holographic data storage devices 100, 200, 300, 500 for recording data in a volumetric holographic medium 102, 202, 302, 502, wherein the data storage device 100, 200, 300, 500 is configured to record data in the volumetric holographic medium 102, 202, 302, 502 in at least a first data page and a second data page, and wherein the first data page and the second data page include identical data. As the first and second data pages contain identical data, correct reading of the data can be verified by comparing the data from the first and second data pages. In this way, defects in the holographic medium 102, 202, 302, 502 or defects in the interference structure recorded in the holographic medium 102, 202, 302, 502 which otherwise might have resulted in an error in data read from the holographic medium 102, 202, 302, 502 can be identified and corrected.

The data storage devices 100, 200, 300, 500 may be configured to record data in the volumetric holographic medium in a microgram.

The data storage devices 100, 200, 300, 500 may be further configured to record data in the volumetric holographic medium 102, 202, 302, 502 in an array of micrograms within a single interference structure in the volumetric holographic medium 102, 202, 302, 502.

As will be appreciated, the data storage device 100, 200, 300, 500 may be used to provide a volumetric hologram including a volumetric holographic medium 102, 202, 302, 502, the volumetric holographic medium 102, 202, 302, 502 including an interference structure which when illuminated displays at least a first data page and a second data page, and wherein the first data page and the second data page include identical data. This may provide the advantages described above, specifically verifiable data storage.

The data storage device 100, 200, 300, 500 may be configured to record data in the volumetric holographic medium 102, 202, 302, 502 in a hexagonal array of discrete data pages by recording multiple optical interference structures in a hexagonal or other geometric array. As described above, an example hexagonal array is shown in FIG. 8. Such hexagonal arrays may facilitate efficient recording of data within the volumetric holographic medium 102, 202, 302, 502; in particular, efficient packing of the interference structures within the volumetric holographic medium 102, 202, 302, 502.

The hexagonal or other geometric array may be within a hexagonal or other geometric array. Such nested arrays may provide efficient packing of the interference structures within the volumetric holographic medium 102, 202, 302, 502.

As will be appreciated, the data storage device 100, 200, 300, 500 may be used to provide a volumetric hologram including a volumetric holographic medium 102, 202, 302, 502, the volumetric holographic medium 102, 202, 302, 502 including an interference structure which when illuminated displays a hexagonal array of discrete data pages. This may provide the advantages described above, specifically efficient data storage.

As will be appreciated, the data storage device 100, 200, 300, 500 may also be used to provide a volumetric hologram including a volumetric holographic medium 102, 202, 302, 502 the volumetric holographic medium 102, 202, 302, 502 including a hexagonal array of interference structures, each interference structure containing a discrete data page. This may also provide the advantages described above, specifically efficient data storage.

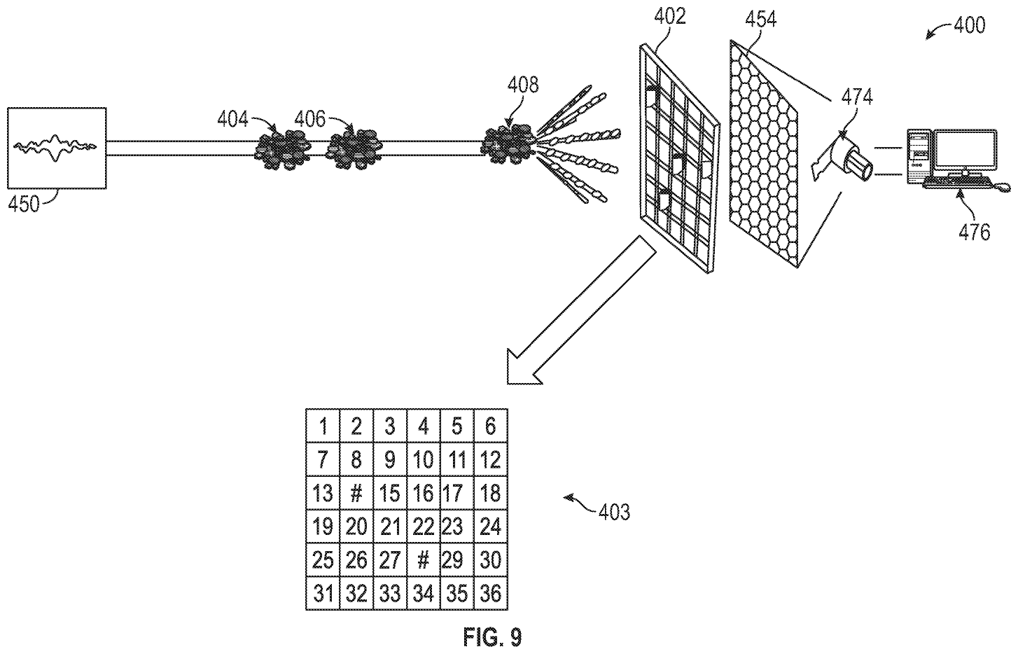

As shown with reference to FIG. 9, there is also provided a volumetric holographic data storage device 400 for reading data from a volumetric holographic medium 402. The volumetric holographic data storage device 400 is configured to read data from at least a first data page and a second data page of the volumetric holographic medium 402. The data storage device 400 is configured to verify accurate reading of the data by comparing data from the first data page and data from the second data page. As above, since the first and second data pages contain identical data, correct reading of the data can be verified by comparing the data from the first and second data pages. In this way, defects in the holographic medium 402 or defects in the interference structure recorded in the holographic medium 402 which otherwise might have resulted in an error in data read from the holographic medium 402 can be identified and corrected.

Also as shown with reference to FIG. 9, there is also provided a volumetric holographic data storage device 400 for reading data from a volumetric holographic medium 402, wherein the volumetric holographic data storage device 400 is configured to read data from a volumetric holographic medium 402 by illuminating the volumetric holographic medium 402 by diffracting light with a volumetric holographic optical element. As shown in FIG. 9, the volumetric holographic data storage device 400 may include three such HOEs. In particular, as shown, the volumetric holographic data storage device 400 may include a first volumetric HOE 404, a second volumetric HOE 406, and/or a third volumetric HOE 408. Also as shown, the first volumetric HOE 404 may be a multi-functional HOE, the second volumetric HOE 406 may be a multi-functional HOE, and/or the third volumetric HOE 408 may be a multi-functional HOE.

As above, the multi-functional HOEs 404, 406, 408 may include at least a first and a second volumetric holographic optical element. The first and second volumetric holographic optical elements may be recorded in the same holographic optical element medium. The first and second volumetric holographic optical elements may be recorded in the same holographic optical element medium by: wavelength multiplexing; angular multiplexing; phase multiplexing; and/or spatial multiplexing. Accordingly, the function of the multi-functional HOE 404, 406, 408 may be selected by varying the wavelength of illumination, angle of illumination, phase of illumination, and/or location of illumination. As an example, where wavelength multiplexing is used, by changing the wavelength of illumination, the function of the multi-functional HOE may be changed. In such a case, when illuminated at a first wavelength the multi-functional HOE 404, 406, 408 may function as a first lens, for example, and when illuminated at a second wavelength the multi-functional HOE 404, 406, 408 may function as a second lens, for example. In such a case, the holographic optical element medium may have recorded in it first and second interference structures which provide the first and second volumetric HOEs. As will be apparent, the use of such multi-functional HOEs may be advantageous, as, for example, volumetric holographic data storage devices 400 having fewer components can be provided.

Further, the multi-functional HOEs 404, 406, 408 may be used to target specific areas of the volumetric holographic medium 402. For example, as shown with reference to the enlarged view of the volumetric holographic medium 402, indicated generally at 403, the multi-functional HOEs 404, 406, 408 can be used to target specific areas, or data pages, of the volumetric holographic medium 402. As an example, FIG. 9 shows two cells 14 and 28 of the volumetric holographic medium 402 being targeted by the multi-functional HOEs 404, 406, 408.

The volumetric holographic data storage devices 100, 200, 300, 400, 500 described with reference to FIGS. 1 to 7, 9, and 10 in addition to the features described above may include conventional features of volumetric holographic data storage devices. For example, the volumetric holographic data storage devices 100, 200, 300, 400, 500 may include a light source, such as a coherent monochromatic light source, e.g. laser light 150, 250, 350, 450, 550, 550′. The volumetric holographic data storage devices 100, 200, 300, 400, 500 may include a beam splitter 152, 352, 552 the beam splitter may be a polarizing beam splitter. Consequently, the volumetric holographic data storage devices 100, 200, 300, 400, 500 may include a signal beam 154, 354, 454, 554 (which may be an object beam) and/or a reference beam 156, 356, 556. Further, the volumetric holographic data storage devices 100, 200, 300, 400, 500 may include a mirror 158, 358, 558, 558′. The mirrors may be arranged appropriately, as is known in the art. The volumetric holographic data storage devices 100, 200, 300, 400, 500 may include a spatial light modulator (SLM) 160, 260, 360, 560 and/or a photonegative 361. Additionally or alternatively, a digital micro mirror device (DMD) or signal modulator (SM) may be used, as is known in the art. The volumetric holographic data storage devices 100, 200, 300, 400, 500 may include a laser dump 162, as is known in the art. The volumetric holographic data storage devices 100, 200, 300, 400, 500 may include one or more objective lens(es) 164, 364, as is known in the art. The volumetric holographic data storage devices 100, 200, 300, 400, 500 may include a Fourier transform lens 166, as is known in the art. The volumetric holographic data storage devices 100, 200, 300, 400, 500 may include a collimating lens 368, 568 as is known in the art. The volumetric holographic data storage devices 100, 200, 300, 400, 500 may include neutral density filters 370, as is known in the art. The volumetric holographic data storage devices 100, 200, 300, 400, 500 may include field lenses 372, as is known in the art. The volumetric holographic data storage devices 100, 200, 300, 400, 500 may include a photo detector diode 474 which is configured to read data from the volumetric holographic medium 102, 202, 302, 402, 502 as is known in the art. The photo detector diode 474 may be connected to a computer 476 for reception or onward transmission of data read by the volumetric holographic data storage devices 100, 200, 300, 400, 500. The volumetric holographic data storage devices 100, 200, 300, 400, 500 may include a beam combiner 376, as is known in the art.

The volumetric holographic data storage devices 100, 200, 300, 400, 500 described herein may use any volumetric holographic medium 102, 202, 302, 402, 502 in which it is possible to record an interference structure, as is known per se. The volumetric holographic medium 102, 202, 302, 402, 502 will be selected based on known properties of the medium; for example, certain media permit multiple exposures to record multiple interference structures in the same portion of the medium and others require simultaneous exposure to record multiple interference structures in the same portion of the medium (e.g. wavelength multiplexed or angular multiplexed interference structures).

As will be apparent, the volumetric holographic data storage devices 100, 200, 300, 400, 500 described herein may further include one or more or all of the features of the other volumetric holographic data storage devices 100, 200, 300, 400, 500 described herein. In particular, the advantages of each volumetric holographic data storage device 100, 200, 300, 400, 500 may be obtained in combination with the advantages of the other volumetric holographic data storage devices 100, 200, 300, 400, 500 described herein.

As will be apparent, this specification provides the use of a Holographic Optical Elements in data storage. Generally, the HOEs will be volumetric HOEs. Further, this specification provides optimisation of volumetric holographic data storage devices 100, 200, 300, 400, 500 including HOEs for both recording and storage of digital data. In particular, the use of HOEs (which may operate in visible or non-visible frequencies) in digital information storage is a key development of this specification.

When used in this specification and claims, the terms “includes”, “including”, “comprises”, and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. A volumetric holographic data storage device for recording data in a volumetric holographic medium and/or reading data from a volumetric holographic medium,
the volumetric holographic data storage device including at least one volumetric holographic optical element.

2. The volumetric holographic data storage device according to claim 1, wherein the at least one volumetric holographic optical element includes:
a random phase mask HOE;
an edge-lit HOE;
a beam splitting HOE;
an objective lens HOE;
a Fourier transform lens HOE;
a focusing HOE;
an expanding HOE
a mirror HOE;
a beam shaping HOE;
a redirection HOE;
a polarization/half-wave plate/quarter-wave plate HOE;
a lens HOE;
a beam combiner HOE;
a fibre optic coupling HOE;
a data memory HOE;
a Fresnel lens HOE; and/or
a microgram within a microgram HOE.

3. The volumetric holographic data storage device according to claim 2, wherein the at least one volumetric holographic optical element includes a random phase mask HOE.

4. The volumetric holographic data storage device according to claim 2 or 3, wherein the at least one volumetric holographic optical element includes an edge lit HOE.

5. The volumetric holographic data storage device according to any of claims 2 to 4, wherein the at least one volumetric holographic optical element includes a beam shaping HOE.

6. The volumetric holographic data storage device according to claim 5, wherein the beam shaping HOE is configured to reshape a Gaussian light intensity distribution to a flat-top light intensity distribution.

7. The volumetric holographic data storage device according to any preceding claim, wherein the volumetric holographic data storage device is configured to record data in the volumetric holographic medium by:
wavelength multiplexing;
angular multiplexing;
phase multiplexing; and/or
spatial multiplexing.

8. The volumetric holographic data storage device according to any preceding claim, wherein the at least one volumetric holographic optical element includes a first and a second volumetric holographic optical element, and
wherein the first and second volumetric holographic optical elements are recorded in the same holographic optical element medium.

9. The volumetric holographic data storage device according to claim 8, wherein the first and second volumetric holographic optical elements are recorded in the same holographic optical element medium by:
wavelength multiplexing;
angular multiplexing;
phase multiplexing; and/or
spatial multiplexing.

10. The volumetric holographic data storage device according to any preceding claim,
further including a further volumetric holographic optical element,
wherein the volumetric holographic data storage device is configured to record data in the volumetric holographic medium by diffracting light with the first and/or, if present, the second volumetric holographic optical element and diffracting light with the further volumetric holographic optical element to the volumetric holographic medium.

11. A volumetric holographic data storage device for recording data in a volumetric holographic medium,
the volumetric holographic data storage device including an arrangement for projecting an image containing data onto a random phase mask such that the image can be recorded in the volumetric holographic medium.

12. The volumetric holographic data storage device according to claim 11, wherein the random phase mask is a random phase mask HOE.

13. The volumetric holographic data storage device according to claim 11, wherein the random phase mask is a random phase mask DOE.

14. The volumetric holographic data storage device according to any of claims 11 to 13, wherein the random phase mask is a wavelength selective random phase mask.

15. The volumetric holographic data storage device according to any of claims 11 to 13, wherein the random phase mask is a panchromatic random phase mask.

16. The volumetric holographic data storage device according to any of claims 11 to 15, wherein the random phase mask is a beam shaping random phase mask.

17. The volumetric holographic data storage device according to any of claims 11 to 16, further including a parallax barrier between the random phase mask and the volumetric holographic medium.

18. A volumetric holographic data storage device for recording data in a volumetric holographic medium and/or reading data from a volumetric holographic medium,
the volumetric holographic data storage device including at least one optical fibre for carrying a signal beam and/or a reference beam.

19. A volumetric holographic data storage device according to claim 18, further including a Spatial Light Modulator (SLM) and/or Digital Micromirror Device (DMD) and the optical fibre is configured to carry information to or from the SLM and/or DMD.

20. A volumetric holographic data storage device according to claim 18 or 19, wherein the optical fibre is a single mode fibre.

21. A volumetric holographic data storage device according to claim 18, 19 or 20, further including a volumetric holographic optical element.

22. A volumetric holographic data storage device according to claim 21, wherein the volumetric holographic optical element is configured to focus the signal beam and/or reference beam into the optical fibre.

23. A volumetric holographic data storage device according to any of claims 18 to 22, further including one or more or all of the features as set out in claims 1 to 17.

24. A volumetric holographic data storage device for recording data in a volumetric holographic medium,
wherein the data storage device is configured to record data in the volumetric holographic medium by passing light (such as coherent monochromatic light, e.g. laser light) through or reflecting light (such as coherent monochromatic light, e.g. laser light) off a Spatial Light Modulator and/or a digital micromirror device (DMD) to the volumetric holographic medium,
and wherein between the Spatial Light Modulator and/or a digital micromirror device (DMD) and the volumetric holographic medium the image is compressed by a factor of at least 10⁻², 10⁻³, 10⁻⁴, 10⁻⁵, or 10⁻⁶.

25. The volumetric holographic data storage device of claim 24, wherein the volumetric holographic data storage device is further configured to record data by:
wavelength multiplexing;
angular multiplexing;
phase multiplexing; and/or
spatial multiplexing.

26. The volumetric holographic data storage device of claim 24 or 25, wherein the volumetric holographic data storage device is further configured to read data by:
wavelength demultiplexing;
angular demultiplexing;
phase demultiplexing; and/or
spatial demultiplexing.

27. A volumetric holographic data storage device for recording data in a volumetric holographic medium,
wherein the data storage device is configured to record data in the volumetric holographic medium in at least a first data page and a second data page,
and wherein the first data page and the second data page include identical data.

28. The volumetric holographic data storage device of claim 27, wherein the data storage device is configured to record data in the volumetric holographic medium in a microgram.

29. The volumetric holographic data storage device of claim 28, wherein the data storage device is configured to record data in the volumetric holographic medium in an array of micrograms within a single interference structure in the volumetric holographic medium.

30. The volumetric holographic data storage device of claim 27, 28, or 29, wherein the data storage device is configured to record data in the volumetric holographic medium in a hexagonal array of discrete data pages by recording multiple optical interference structures in a hexagonal or other geometric array,
optionally wherein the hexagonal or other geometric array is within a hexagonal or other geometric array.

31. A volumetric holographic data storage device for reading data from a volumetric holographic medium,
wherein the volumetric holographic data storage device is configured to read data from at least a first data page and a second data page of the volumetric holographic medium,
and wherein data storage device is configured to verify accurate reading of the data by comparing data from the first data page and data from the second data page.

32. A volumetric holographic data storage device for reading data from a volumetric holographic medium,
wherein the volumetric holographic data storage device is configured to read data from a volumetric holographic medium by illuminating the volumetric holographic medium by diffracting light with a volumetric holographic optical element.

33. The volumetric holographic data storage device of claim 32, wherein the volumetric holographic data storage device is further configured to read data by:
wavelength demultiplexing;
angular demultiplexing;
phase demultiplexing; and/or
spatial demultiplexing.

34. A volumetric hologram including a volumetric holographic medium, the volumetric holographic medium including an interference structure which when illuminated displays a projection of a data page information on a hologram or random phase mask.

35. A volumetric hologram including a volumetric holographic medium, the volumetric holographic medium including an interference structure which when illuminated displays at least a first data page and a second data page,
and wherein the first data page and the second data page include identical data.

36. A volumetric hologram including a volumetric holographic medium, the volumetric holographic medium including at least a first interference structure which when illuminated displays a first data page and a second interference structure which when illuminated displays a second data page,
and wherein the first data page and the second data page include identical data.

37. Use of a Holographic Optical Element in data storage.
